(19) United States
(12) Patent Application Publication
(10) Pub. No.: US 2012/0272483 A1
(43) Pub. Date: Nov. 1, 2012

(54) SUNGLASSES RETAINER FOR CAPS

(76) Inventor: Michael L. Moore, Round Rock, TX (US)

(21) Appl. No.: 13/458,332

(22) Filed: Apr. 27, 2012

Related U.S. Application Data
(60) Provisional application No. 61/480,484, filed on Apr. 29, 2011.

(51) Int. Cl. F16B 2/20; B23P 15/00; B29C 69/02; B23P 11/00

(52) U.S. Cl. 24/3.3; 29/428; 72/324; 29/896.9; 24/3.12; 264/241

(57) ABSTRACT

A clip retains eyeglasses to a cap. The clip includes an inner blade, outer blade, and bottom segment connected to the inner and outer blades. The bottom segment separates the inner blade from the outer blade forming a slot, and biases the inner blade towards the outer blade. An arm connected to the outer blade wedgingly retains a temple arm of eyeglasses. A display device is connected to the outer blade where visible to an observer, and provides promotional emblems, logo, picture, photo, colors, team symbol and the like. The display device may be removable and replaceable.

### CROSS-REFERENCE TO RELATED APPLICATION

This application is a conversion of and claims benefit of priority of U.S. Provisional Patent Application Ser. No. 61/480,484, filed Apr. 29, 2011, titled “Sunglasses Retainer For Caps”, of Michael L. Moore, which provisional application is co-pending and has at least one same inventor of the present application. The provisional application is hereby incorporated herein by this reference.

### TECHNICAL FIELD

The present invention generally relates to hat clips, and more particularly relates to retainer clips for holding glasses, sunglasses or other implements to a cap or hat, providing interchangeable promotional displays.

### BACKGROUND

Hats, caps and other similar headwear (collectively, “caps” or “hats” throughout), for example, baseball caps and others, are widely worn, traded, distributed for promotional purposes, and collected. Caps are worn for various reasons, such as to block direct sunlight, as fashion wear, to shield the scalp, to restrain hair, to promote emblems or labels, combinations of these, or others. Cap wearers typically find themselves in situations where light intensity varies because of shadows, travel into buildings or under covers, time of day, and so forth.

Sunglasses (or other eyeglasses) are often worn as complement to a cap for daylight activities or other bright lighting situation. When the sunglasses are removed, the wearer must carry or stow the sunglasses to avoid loss or damage. A common practice is to place the lens frame portion of the sunglasses on the bill of the cap with the temple arms of the sunglasses extending along the headband of the cap on the wearer's head. Other practices include lodging the sunglasses over the head with temple arms extending downward, placing the glasses in a shirt or pants pocket, leashes or straps, and similar. These practices are often not suitable, however, because the sunglasses easily slip from the cap bill or head, fall from or are crushed in pockets, and otherwise. Loss, damage and inconvenience result.

Others have proposed certain clips or retainers for use for glasses in conjunction with caps. These have not been suitable or widely adopted. Some have limited use for specific type of headwear, such as hard hats, and would not otherwise operate. Others lack sufficient gripping capability to effectively retain glasses with or attached to the wearer or headwear. Other problems presented include bulkiness, cumbersome nature or use, or less than desirable appearance. Certain of these interfere with or impede eyesight in use. Consequently, others have not proposed acceptable solutions to fill needs.

It would therefore be desirable to provide new and improved systems and methods for retaining eye glasses in conjunction with a cap. These systems and methods would be particularly desirable if operable during activity, work, play and the like, where varied and exaggerated movement of the user is present. Other desirable characteristics of these systems and methods would include effective grip to avoid slip or disengagement of glasses, simplified use, and adaptability for wide variety and varied sizing and configuration of caps and hats. Other desirable characteristics would include an appealing appearance and lack of interference or impediment to eyesight and movement. Desirability of the systems and methods would be furthered by providing displays and variable displays, for example, for promotional purposes.

### SUMMARY

An embodiment of the invention is a system removably connected to an edge of a crown of a hat for retaining an elongate implement to the hat. The system includes a first spring, a first lever connected to the first spring, a second lever connected to the first spring, the second lever is biased by the first spring towards the first lever, and vice versa. The system also includes a second spring connected to the first lever, a third lever connected to the second spring, and a display connected to the first lever. The display is visually observable, in entirety, viewing the first lever towards the second lever.

Another embodiments of the invention is a clip for retaining eye glasses to a billed cap. The billed cap includes a crown with a crown edge, a headband along the crown edge, and a bill connected to a portion of the crown edge. The eye glasses include a lens portion and a first temple arm and second temple arm connected to the lens portion. The clip includes an inner blade, an outer blade, and a bottom segment connected to the inner blade and the outer blade. The bottom segment separates, at least in part, the inner blade from the outer blade forming a slot between the inner blade and the outer blade, and the bottom segment biases the inner blade towards the outer blade within the slot. The clip also includes an arm connected to the outer blade opposite the slot. The arm is sized to wedgingly accept either the first temple arm or the second temple arm between the arm and the outer blade. A display device of the clip is connected to the outer blade away from the arm.

Yet another embodiment of the invention is a method of manufacture of a clip for retaining eye glasses to a billed cap. The method includes molding an inner blade having a mediately disposed arm and an aperture, and a bottom segment connecting the inner blade and the outer blade nearer to the aperture than the arm, the bottom segment separates, at least in part, the inner blade from the outer blade by a slot between the inner blade and the outer blade opposite the arm, forming a display button having a stem connectable to the aperture.

Another embodiment of the invention is a method of manufacture of a system for retaining eye glasses to a billed cap. The method includes bending a metal strip to form a first spring connected to a first leaf and a second leaf, the first leaf and the second leaf are separated by a slot, cutting a retainer from a mediate portion of the first leaf, to form a branch of the first leaf, bending the branch to form a second spring connected to the first leaf and the branch, forming a connector of the first leaf between the first spring and the second spring, and providing a button attachable to the connector.

### BRIEF DESCRIPTION OF THE DRAWINGS

The present invention is illustrated by way of example and not limitation in the accompanying figures, in which like references indicate similar elements, and in which:

FIG. 1 illustrates a right side perspective view of a system for retaining a slender elongate instrument, for example, a temple arm of eye glasses, such as sunglasses, to a cap, with the lens portion of the eye glasses resting on the brim of the cap, including the cap and eye glasses in phantom, according to certain embodiments of the invention;

FIGS. 2A-C illustrate a right side perspective view, a right side view, and another right side view of a clip system for a display and for retaining an implement to a hat, according to certain embodiments of the invention;

FIG. 3 illustrates a right side perspective view in cross-section along A-A′ of FIGS. 2A-C, of a display unit and connector of a system for a hat, according to embodiments of the invention;

FIG. 4 illustrates a right side perspective view of an alternative system for retaining an implement to a cap, according to embodiments of the invention;

FIG. 5 illustrates a right side perspective view in cross-section along line A-A′ of FIG. 3, of a display unit, including a pin and stem connector, for a hat clip, according to certain embodiments of the invention;

FIG. 6 illustrates a right side perspective view of an alternative system of a unit for attachment to a cap to retain an implement to the cap, according to certain embodiments of the invention;

FIG. 7 illustrates a right side perspective view in cross-section along B-B′ of FIG. 6, of a fixedly or removably connected display device, according to certain embodiments of the invention.

### DETAILED DESCRIPTION

Referring to FIG. 1, a system 100 is removably attached to a hat 102 (shown in phantom) at the bottom edge portion of the crown of the hat 102, to retain a temple arm of a set of eye glasses 104. The system 100 includes a bottom bend 110 configured to conform to a portion of the bottom edge of the crown of the hat 102. The bottom bend 110 connects to an outer elongate extension 108 and an inner elongate extension 106. The bottom bend 110 and the elongate extensions 108, 106 form a generally U-shape in cross-section A-A′, with the bottom bend 110 being the bottom and the elongate extensions 108, 106 branching as respective sides.

The outer elongate extension 108 is connected to a clip arm 112. The arm 112 extends from the outer elongate extension 108 forming a generally u-shape in cross-section A-A′, with the outer elongate extension 108 being the right generally straight side and the arm 112 forming the bottom curved and left portion of the u-shape. The arm 112 is capable of clamping an elongate structure, for example, the temple arm of eye glasses or sunglasses of FIG. 1 or other elongate structure having cross-section wedgingly accommodated between the arm 112 and the outer elongate extension 108. The arm 112 clamps the elongate structure between the arm 112 and the outer elongate extension 108 sufficiently to retain the elongate structure when placed therebetween and during movement of the hat in wear, but to permit manual force removal of the elongate structure when desired.

In operation during use, the bottom edge of the crown of the hat 102 is lodged between the inner elongate extension 106 (inside of crown) and the outer elongate extension 108 (outside of crown) of the system 100, with the bottom bend 110 between the elongate extensions 106, 108 abutting a bottom edge portion of the crown of the hat 102. The extensions 106, 108, in use, clamp the bottom edge and headband portion of the crown sufficiently to retain in position to the hat 102, the system 100 and an elongate structure (e.g., a temple arm of glasses) located between the arm 112 and the elongate extension 108. The system 100 can be located along any portion of the bottom edge of the crown of the hat 102 where not restricted by a bill or brim, for example, along a left or right side of the hat 102 (relative to sides of the hat wearer).

One or more of the system 100 can be concurrently employed with the hat 102, for example, one of the system 100 can be located on one side of the hat from a bill of the hat and another of the system 100 can be located on the other side of the hat from the bill. In the system 100 in use with a billed or brimmed hat, eye glasses 104 (for example, sunglasses or others) are placed with lens frame portion on the bill or brim of the hat, with a temple arm of the glasses 104 extending on each side of the hat crown. A temple arm of the glasses is positioned by the user between the arm 112 and the elongate extension 108 of the system 100, to wedgingly clamp the temple arm therein. If more than one of the system 100, for example, two, are used with a billed hat, the system 100 on one side of the hat crown clamps one temple arm of the glasses and the system 100 on the other side of the crown clamps the other temple arm. Two of the system 100 employed in this manner provides greater support and retention for the glasses with lens frame portion resting on the hat bill.

The outer elongate extension 108, e.g., on an outwardly visible side of the elongate extension 108 from the inner elongate extension 106, includes a display 114. The display 114 is, for example, a button, snap, label, or emblem, attached to the elongate extension 108. The display 114 is located in attachment below the arm 112 and above the bottom bend 110, for outward visibility to others. The display 114 is alternately attached to the elongate extension 108 above the arm 112, for example, as a cap, top, label, pin, button or wrapped segment, at or towards the distal end of the extension 108 opposite the bottom bend 110 (but above the arm 112, for visibility of the display). The display 114 is either rigidly connected to the elongate extension 108, formed integral with or as part of the elongate extension 108, or attached in removable manner with the elongate extension 108 to allow (as may be desired) swap, replacement, or removal of the display 114, or combinations of these.

One or both of the outer elongate extension 108 and the inner elongate extension 106 includes one or more ridge 116 formed to frictionally engage the headband and/or bottom edge portion of the crown of the hat 102 when the bottom edge portion is lodged between the extensions 106,108. The arm 112 includes one or more ridge 118 formed to aid clamping, positioning, and/or retention of an elongate structure positioned between the arm 112 and the outer elongate extension 108. In certain alternatives, additional, fewer, varied, or other ridges 116, 118 are possible in the system 100. Ridges 116 and/or 118 are not necessary and need not be included, for example, if the system 100 otherwise sufficiently engages the hat 102 and/or the arm 112 and outer elongate extension 108 sufficiently wedge the temple arm, respectively.

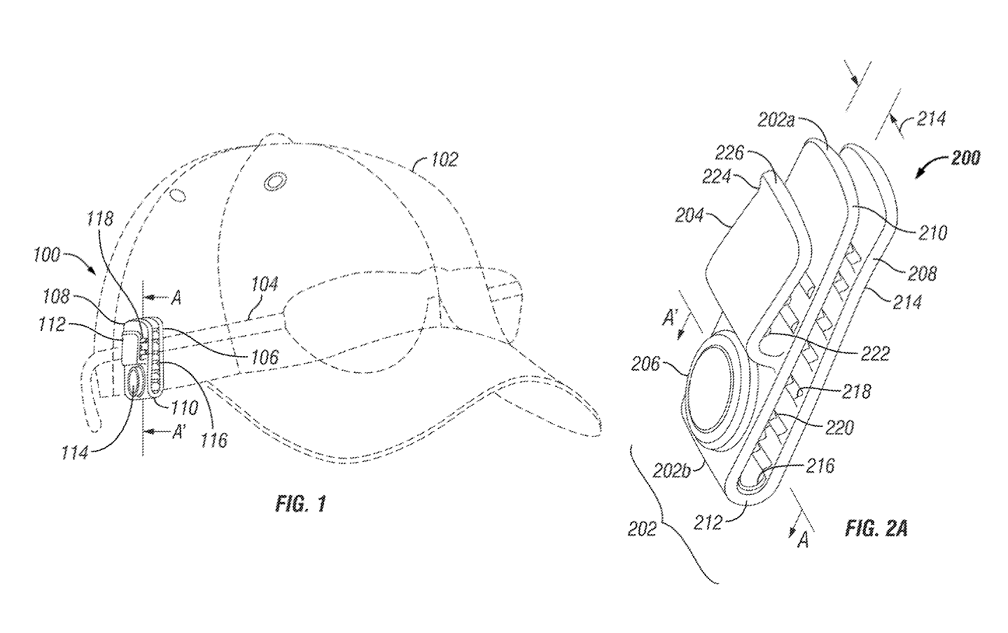

Referring to FIGS. 2A-C, a clip system 200 includes a body 202. The body 202 includes an inner blade 208 and an outer blade 210 connected at a lower end 202b (in the orientation of FIG. 2A) by a bottom segment 212. The bottom segment 212 positions the outer blade 210 with respect to the inner blade 208 forming a slot 214 between inner blade 208 and outer blade 210 for receiving an edge of the crown of a hat in the slot 214. The bottom segment 212, in conjunction with the outer blade 210 and inner blade 208, biases the inner blade 208 towards the outer blade 208 (and vice versa) in the slot 214, sufficiently to retain the system 200 to the headband and edge of the crown of the hat when positioned in the slot 214 but to allow manual removal of the system 200 from the hat when so desired.

When the system 200 is not in use attached to the hat, the inner blade 208 is positioned by the bottom segment 212 about parallel to the outer blade 210 or else inwardly directed in the slot 214 towards the outer blade 210. For example, if the outer blade 210 is inwardly directed in the slot 214, the bottom segment 212 biases into or about into contact with the outer blade 210 at an upper end 202a (in the orientation of FIG. 2A). The particular relative positioning of the blades 210, 208 by the bottom segment 212, and the bias provided by the bottom segment 212, are configured sufficiently rigid to bias the blades 208, 210 deflecting inwardly in the slot 214 to retain the system 200 to the headband and edge of the crown of the hat, but also sufficiently flexible to allow the blades 210, 208 to be separated (widening the slot 214) by hand to insert the edge of the hat into the slot 214 and to remove the system 200 from the hat when so desired.

The inner blade 208 of the system 200 includes a slight deflection or bend portion 214 in an upper end (in the orientation of FIG. 2A) of the inner blade 208. The bend portion 214 of the inner blade 208 deflects away from the outer blade 210. The bend portion 214 allows the bottom segment 212 to further bias the inner blade 208 towards the outer blade 210, and provides additional surface area of the inner blade 208 for contact with the headband and edge of the crown of the hat. A wide variety of thicknesses of headband, edge and crown of caps are accommodated by the system 200.

The bottom segment 212 includes a rib 212a, for example, a portion of or attached to the bottom segment 212 of greater rigidity/thickness than that of the blades 208, 210. The rib 212a increases bias strength of the bottom segment 212. In alternatives, the rib 212a is a spring device connected to the bottom segment 212 to provide additional or desired biasing of the blades 208, 210, via the bottom segment 212 connected to the rib 212a. In other alternatives, if the bottom segment 212 and the blades 208, 210 provide sufficient bias and retention, for example, if sufficient bias is provided by particular materials of the system 200, the system 200 need not necessarily include the rib 212a and/or the bend portion 214.

The inner blade 208 includes one or more ridge 218 facing the slot 214. The ridge 218, together with biasing, aids in retaining the system 200 to the headband and edge of the crown of the hat. The outer blade 210 also includes one or more ridge 220 facing the slot 214, to aid retaining the system 200. The ridges 218 and 220, respectively, are offset in relative position in orientation on the blades 210, 208, respectively, for example, each ridge 220 of the outer blade 210 locates in the vicinity of between two of the ridges 218 of the inner blade 208. In alternatives, the ridges 218, 220, or either of them, can be bumps, channels, barbs, or other configurations providing engagement for retention of the system 200 with the hat. In other alternatives, the bottom segment 212 provides sufficient bias of the blades 210, 208, and ridges 218 or other frictional/engagement elements of the blades 210, 208 need not necessarily be included. In other alternatives, the system 200 includes additional or fewer of the ridges 218 or 220.

A hook arm 204 of the system 200 is connected, for example, about midway between the upper end and the lower end (in the orientation of FIG. 2A), to the outer blade 210 opposite the slot 214. The hook arm 204 extends about perpendicularly from connection to the outer blade 210, and then arcuately angles, extending generally towards the upper end 202a (in the orientation of FIG. 2A) of the system 200 and spaced from the outer blade 210. The hook arm 204, towards an arm end 226, includes a bend portion 224 deflecting away from the outer blade 210. The hook arm 204 is sized and angled, and spaced from the outer blade 210, to accommodate a cross-section of an elongate temple arm of eye glasses, or other similar elongate and/or slender implement. The hook arm 204 flexes with respect to the outer blade 2100 sufficient for insertion of the implement between the arm 204 and the outer blade 210, and to wedgingly retain the implement by the arm 204 and the outer blade 210 as inserted. Flex of the hook arm 204 in connection to the outer blade 210 also permits widening of space between the arm end 226 and the outer blade 210 for manual placement and crook nesting of the implement in the hook arm 204 next to the outer blade 210 and for manual removal of the implement.

The system 200 includes a visual display 206 connected to the body 202. The visual display 206 is incorporated with or formed integral to the body 202, or is removably connected to the body 202. If removably connected, the visual display 206 is replaceable, for example, a variety of differently appearing displays, both in visual appearance of color, motif, portrait, picture, logo, or other visual content, as well as in observable shape, are interchangeably connectable, by swapping, replacement or substitution, to the body 202, as desired by the user. The visual display 206 connects to or is integrated to the body 202 on an outwardly appearing surface of the body 202 during use of the system 200 worn on the hat, for example, the display 206 is located below or above the hook arm 204 on the outer blade 210 opposite the slot 214. The visual display 206 is also located to avoid interference with operation of the blades 210, 208 and bottom segment 212 for engaging the hat, and the hook arm 204 and outer blade 210 for receiving, wedgingly retaining, and manual removing the temple arm of glasses or other engaged implement.

Referring to FIG. 3, in conjunction with FIGS. 2A-C, a display unit 300 in cross-section taken along A-A′ of the body 200, includes a swappable button 302 of the display 206. For convenience, the display unit 300 is illustrated and described with respect to the system 200 of FIGS. 2A-C, with like references and elements of FIG. 3 identified as in FIGS. 2A-C; however, the display unit 300 is included in, or can adapted as, the display 114 of the system 100 of FIG. 1 or display(s) of other embodiments. The button 302 includes a token 304 fixed to a frame 302. The frame 302 is shaped to border the token 304. The token 304 provides an outward (upward in the orientation of FIG. 3) surface for display. Although the button 302 may be any of a wide variety of shapes in outward appearance, the button 302 according to certain embodiments has a round outward appearance. The frame 302 includes a protrusion 306 opposite the token 304. The protrusion 306 is formed with a first leg 306a and a second leg 306b, separated by space allowing each leg 306a or 306b to flex towards the other. At an extent of the protrusion 306 from the token 304, each leg 306a and 306b has an outwardly disposed rib 307a, 307b, respectively.

The outer blade 210 of the body 200 includes an aperture 309 through the blade 210. The aperture 309 is formed, for example, in a thin portion 202c of the outer blade 210 or otherwise. The aperture 309 is sized to accept the legs 306a, 306b of the protrusion 306 therethrough, by flex of the legs 306a, 306b positioned at the aperture 309 and force upon button 302 directed at the aperture 309. Force on the button 302 causes the legs 306a, 306b to initially flex together for entry to the aperture of the legs 306a, 306b in location of the ribs 307a, 307b, respectively. Once the ribs 307a, 307b are passed through the aperture 309, the legs 306a, 306b flexingly separate slightly and the ribs 307a, 307b abut and lock against the outer blade 210 within the slot 214. The button 302 is similarly removable from the outer blade 210 by forcing the button 302 away from the blade 210, causing the legs 306a, 306b to flexingly narrow space between the legs 306a, 306b sufficient to allow the ribs 307a, 307b to progress into and from the aperture 309. In this manner, buttons may be swapped or replaced in connection to the body 200.

In operation in use of the system 200, the system 200 is attached to the edge and headband portion of the crown of a cap by sliding the edge and headband portion into the slot 214 between the blades 208, 210 at the upper end (in the orientation of FIG. 2A). Manual pushing or pressing force, and/or other force to slightly spread the slot 214, may be required for locating the edge and headband portion in the slot 214, depending on thickness of material of the edge and headband portion. The system 200 in use is manually positioned at a user's desired location along circumference of the edge and headband portion, with the bottom segment 212 within the slot 214 abutting the edge, the inner blade 208 abutting the inside of the crown of the cap and the outer blade 210 abutting the outside of the crown.

When desired by the user, an elongate implement, such as a temple arm of sunglasses of the like, is manually placed between the hook arm 204 and outer blade 210 the at the arm end 226 and pushed (downwardly in the orientation of FIG. 2A) between the hook arm 204 and the outer blade 210 beyond the bend portion 224. The implement is rested and retained between the hook arm 204 and outer blade 210 during activity and movement. For billed caps, the system 200 retains a temple arm of sunglasses, or other eye glasses, when the lens frame is placed on the bill and the temple arms oriented along sides of the crown and fitted into the system 200. With two of the system 200, one located along the edge and headband on one side and another located on the other side of the cap, a respective temple arm of glasses is retained by each system 100, with the lens frame rested on the bill.

Referring to FIG. 4, an alternative system 400 retains an implement (not shown in FIG. 4) to a cap (not shown in FIG. 4). The system 400 includes a first spring 402 connected to a first lever 404 and a second lever 406. The spring 402 biases the first lever 404 towards the second lever 406, and vice versa, in a space 408 formed between the levers 404, 406. The first spring 402 connected between the first lever 404 and the second lever 406 forms the space 408 of sufficient width to accommodate varied thickness of the edge and headband of a crown of a cap in combination. The spring 402 narrows the space 408 between the first lever 404 and second lever 406 extending progressingly from connection to the first spring 402.

The first lever 404, on a side 404a opposing the space 408, connects to a second spring 410. The second spring 410 connects to a third lever 412 biased by the second spring 410 towards the first lever 404. The second spring 410 forms a space 414 between the third lever 412 and the first lever 404 of sufficient width to wedgingly accommodate thickness/cross-section of an implement, for example, a temple arm of glasses or sunglasses. The second spring 410 narrows the space 414 between the third lever 412 and the first lever 404 as the third lever 412 progresses in extension from the second spring 410.

The first lever 404, on the side 404a, includes or connects to a display 416. The display 416 connects to the first lever 404 where not interfering with operations of the second spring 410 and third lever 412, for example, on the side 404a between the first spring 402 and the second spring 410, or otherwise beyond the third lever 412 on the side 404a.

In certain alternatives, the second lever 406 includes a crook 418 near extent of the second lever 406 from the first spring 402, angling away from the first lever 404. In certain other alternatives, the third lever 412 includes a different crook 420 near extent of the third lever 412 from the second spring 410, angling away from the first lever 404. In certain further alternatives, the first lever 404 and/or the second lever 406, each where adjacent the space 408, include or connect to one or more frictional device 422, for example, the second lever 406 includes two spaced apart frictional devices 422 and the first lever 404 includes two spaced apart frictional devices (not shown in FIG. 4) offset relative to the frictional devices 422 of the second lever 406 in the space 408. In yet certain other alternatives, the frictional elements (not shown in FIG. 4) are included in or connected to the third lever 412 and/or the first lever 404 adjacent the space 414.

In certain further alternatives, the display 416 is removably connected or attached to the side 404a of the first lever 404. In certain other alternatives, the display 416 is fixedly connected to or incorporated in the first lever 404 on the side 404a. The display 416, in certain alternatives, provides a promotional visual object to observers of the system 400 in use with a cap, for example, a team logo, corporate emblem, slogan, campaign, or personalized display, and/or provides color or other ornamentation, jewelry, or the like.

In use, the alternative system 400 is slipped onto an edge and headband portion of the crown of a cap. The first spring 402 biases the first lever 404 and second lever 406 against the edge and headband portion between the levers. An implement, for example, a slender elongate arm, such as a temple arm of eye glasses or sunglasses, is pressed between the third lever 412 and the first lever 404. The second spring 410 biases the third lever 412 against the implement lodged between third lever 412 and the first lever 404 to retain the implement until removed by push from between the third lever 412 and the first lever 404. The display 416, if removably connected or attached to the first lever 404, is replaceable, swappable or removed during use of the system 400, as desired by the cap wearer. The alternative system 400 is pulled from the cap by hand force sufficient to overcome bias and frictional engagement by the first lever 404 and second lever 406, and any frictional devices thereof, to the cap in the space 408.

Referring to FIG. 5, an alternative display unit 500, in similar cross-section orientation to that of the display unit 300 of FIG. 3, includes a pin 502. For convenience, the alternative display unit 500 is illustrated and referenced with respect to the system 400 of FIG. 4, with like references and elements of FIG. 4 identified as in FIG. 5; however, the alternative display unit 300 is included or connected in, or adapted for, any other embodiments. The pin 502 is formed as or with or otherwise includes a visual device 504 fixed to a tack 502. The visual device 504 provides display to others viewing a cap fitted with the embodiments. The pin 502 may be any of a wide variety of shapes in outward appearance, for example, round. The pin 502 includes a stem 506 on opposite side from the visual device 504 of the pin 502. The stem 506, at an extent thereof, forms one or more prominent ridge 506a.

An aperture 508 formed of and through the first lever 404 in desired location for the pin 502 is sized to accept the stem 506 therethrough, but to restrict passage of the one or more ridge 506a unless forced. The first lever 404 may, but need not necessarily, include a select portion 510 adjacent the aperture 508 to ease acceptance of the stem 506 and one or more ridge 506a in the aperture 508. The stem 506 and one or more ridge 506a, in combination, is pressed into and through the aperture 508, extending the stem 508 in the aperture 508 with the one or more ridge 506a exiting the aperture 508. The pin 502 is formed of material, for example, a plastic, rubber or nylon, to resiliently retain shape of the stem 506 and ridge 506a, but for compressibility/malleability sufficient for the one or more ridge 506a to compress when pressed by hand into the aperture 508. After the stem 506 and one or more ridge 506a, in combination, pass through the aperture 508 beyond the one or more ridge 506a, the one or more ridge 506a lock the pin 502 to the first lever 404. The pin 502 is conversely removed from lock to the first lever 404 by forcing, by hand, the stem 506 and one or more ridge 506a, in combination, back through and from the aperture 508.

Referring to FIG. 6, another alternative system 600 includes, as a unit, a first leaf 604 and a second leaf 606, connected to a spring 602. The first leaf 604 mediately branches forming a retainer 608. The retainer 608, in part, extends adjacent to and spaced a distance from the first leaf 604. The spring 602 biases the first leaf 604 towards the second leaf 606, and vice versa, within space between the leafs 604, 602, such that a fabric material (not shown in FIG. 6) inserted between the leafs 604, 602 is engaged/gripped between the leafs 604, 602 retaining the alternative system 600 to the fabric material. The retainer 608 is biases towards the first leaf 604 such that an implement (not shown in FIG. 6), for example, a temple arm of eye glasses, is engaged/held between the retainer 608 and the first leaf 604 when inserted therebetween. When desired by a user, the fabric material is removable, by hand force, from between the leafs 604, 602, and the implement is removable, by hand force, from between the retainer 608 and the first leaf 604.

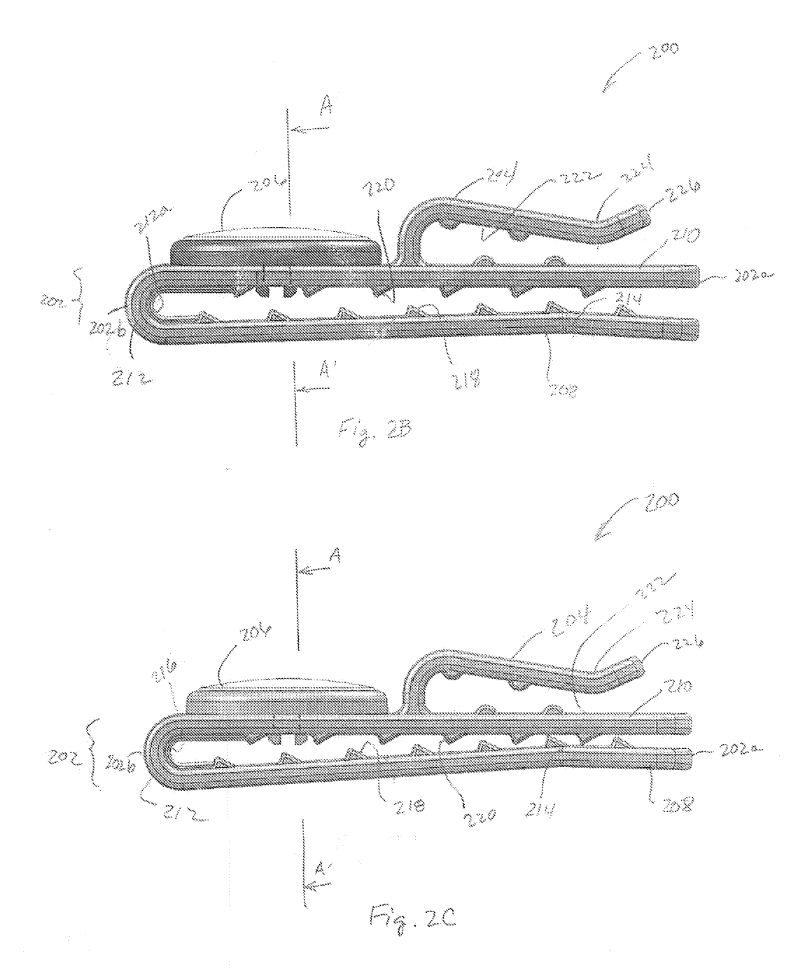

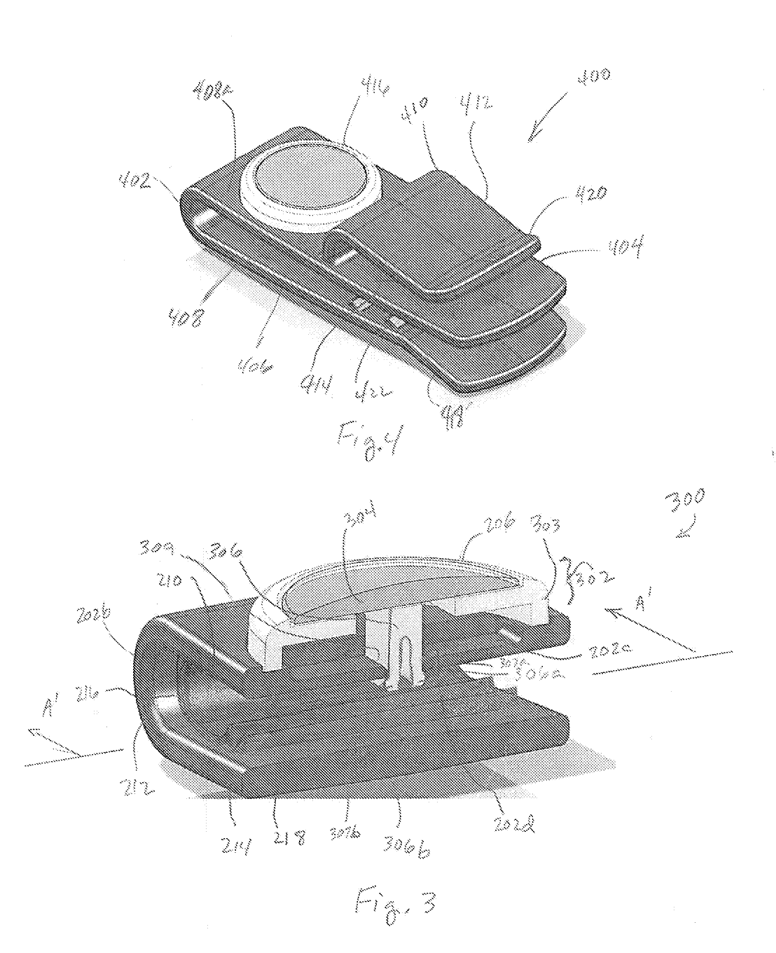

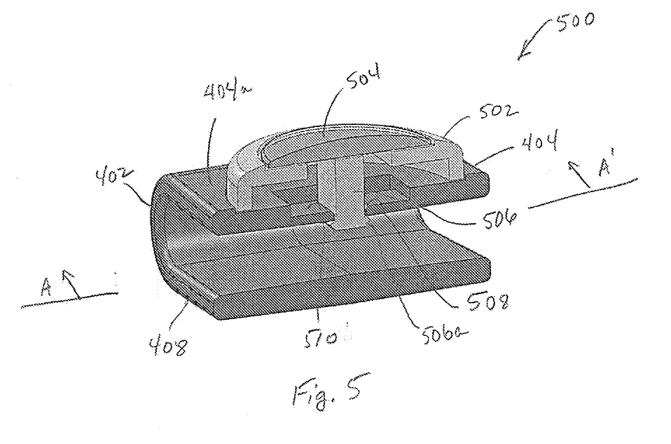

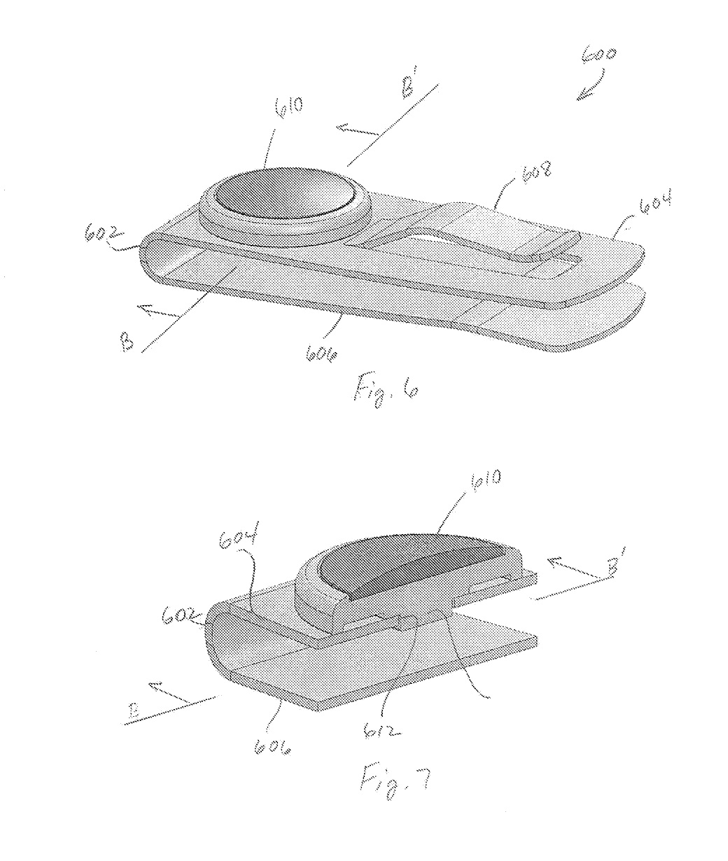

Referring to FIG. 7, in conjunction with FIG. 6, a display device 610 is fixably or removably connectable to the alternative system 600. For example, the first leave 604 forms an aperture 612 in the first leaf 604 between the retainer 608 and the spring 602. The aperture 612 is sized to accept a connector 614 of the display device 610. The display device 610, alternately, is integral to or otherwise removably connected to the first leaf 604.

In use, the alternative system 600 is attached to a billed cap (not shown in FIGS. 6-7) by positioning an edge and headband portion on a side of the cap's crown from the bill, between the first leaf 604 and second leaf 606. The spring 602 is positioned against the edge of the crown, with the edge and headband portion residing between the first leaf 604 and second leaf 606. An implement (not shown in FIGS. 6-7) is then selectively positioned between the retainer 608 and the first leaf 604, with the implement resting therebetween. Two of the alternative system 600 can, in certain alternatives, be employed, one on each side of the crown of the hat. A respective temple arm of eye glasses, for example, sunglasses, is positioned between the retainer 608 and first leaf 604 of the respective system 600 of each side of the crown, and the glasses lens portion rests on the bill of the cap. For any or each system 600, the display device 610, if employed, is fixed (same or different display device) to the system 600, either prior to positioning the system 600 on the hat or when in place on the hat. The display device 610 provides any of a wide variety of visually observable content(s) to the system 600, for example, color, ornamentation, picture, photo, logo, emblem, slogan, jewelry or other ornamentation or adornment element.

The foregoing embodiments are manufactured by extrusion, molding, bending, forming, or other manufacture. Materials of the embodiments include, but are not limited to, plastic, nylon, metal, composite, and others. The embodiments are unitary or certain portions or components are unitary, and/or embodiments include respective parts and components fixed, attached, connected, incorporated or integrated. In certain embodiments, the clip and retainer arm of the clip are a unit, and the display is sepeartely removably or fixedly connected to the unit. As will be apparent, numerous variations in manufacture, materials, parts, units and components are possible, and all such variations are included herein.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system removably connected to an edge of a crown of a hat for retaining an elongate implement to the hat, comprising:
a first spring;
a first lever connected to the spring;
a second lever connected to the spring, the second lever is biased by the first spring towards the first lever, and vice versa;
a second spring connected to the first lever;
a third lever connected to the second spring; and
a display connected to the first lever, visually observable, in entirety, viewing the first lever towards the second lever.

2. The system of claim 1, wherein the display is removably connected to the first lever for replacement of the display.

3. The system of claim 1, further comprising:
at least one ridge, the at least one ridge is selected from the group consisting of: at least one ridge formed in the first lever adjacent the second lever, at least one ridge formed in the second lever adjacent the first lever, at least one ridge formed in the third lever adjacent the first lever, at least one ridge formed in the first lever adjacent the third lever, and any combination of these.

4. The system of claim 1, wherein each of the first lever and the second lever is a respective elongate planar extension, having a first end and a second end, respectively, each connected at the first end, respectively, to the first spring; and
wherein the third lever is an elongate planar extension connected to the first lever about mediately between the first end and the second end.

5. The system of claim 4, wherein the display is connected to the first lever between about the first spring and about mediately between the first end and the second end.

6. A clip for retaining eye glasses to a billed cap, the billed cap includes a crown with a crown edge, a headband along the crown edge, and a bill connected to a portion of the crown edge, the eye glasses include a lens portion and a first temple arm and second temple arm connected to the lens portion, comprising:
an inner blade;
an outer blade;
a bottom segment connected to the inner blade and the outer blade, the bottom segment separates, at least in part, the inner blade from the outer blade forming a slot between the inner blade and the outer blade, the bottom segment biases the inner blade towards the outer blade within the slot;
an arm connected to the outer blade opposite the slot, the arm sized to wedgingly accept either of the first temple arm and the second temple arm between the arm and the outer blade; and
a display device connected to the outer blade away from the arm.

7. The clip of claim 6, further comprising:
two of the clip, each clip attached to respective side of the crown from the bill of the cap, one clip for retaining the first temple arm and the other clip for retaining the second temple arm with the lens portion resting on the bill.

8. The clip of claim 6, wherein the display device is removably connected to the outer blade to allow replacement and swap of the display device.

9. The clip of claim 6, wherein the display device includes a visually observable promotional content.

10. A method of manufacture of a clip for retaining eye glasses to a billed cap, comprising the steps of:
molding an inner blade, an outer blade having a mediately disposed arm and an aperture, and a bottom segment connecting the inner blade and the outer blade nearer to the aperture than the arm, the bottom segment separates, at least in part, the inner blade from the outer blade by a slot between the inner blade and the outer blade opposite the arm; and
forming a display button having a stem connectable to the aperture.

11. The method of claim 10, further comprising the step of:
fixedly connecting the stem of the display button to the aperture of the outer blade.

12. The method of claim 10, wherein the stem of the display button is formed for removable connection to the aperture of the outer blade.

13. The method of claim 10, wherein the step of forming includes providing at least one rib to the stem of the display button, the at least one rib and the stem, in combination, passes through the aperture to retainingly connect the display button to the outer blade and is selectively removable by force from the aperture to disconnect the display button from the outer blade.

14. A method of manufacture of a system for retaining eye glasses to a billed cap, comprising the steps of:
bending a metal strip to form a first spring connected to a first leaf and a second leaf, the first leaf and the second leaf are separated by a slot;
cutting a retainer from a mediate portion of the first leaf, to form a branch of the first leaf;
bending the branch to form a second spring connected to the first leaf and the branch;
forming a connector of the first leaf between the first spring and the second spring; and
providing a button attachable to the connector.

15. The method of claim 14, further comprising the step of:
rigidly connecting the button to the connector.

16. The method of claim 14, wherein the button is removably attachable to the connector.

17. The method of claim 14, further comprising the step of:
bending the second leaf towards an end distal from the first spring, to deflect from the first leaf.

18. The method of claim 14, further comprising the step of:
bending the arm at a mediate portion to form an increased separation of the mediate portion from the first leaf.

19. The method of claim 18, further comprising the step of:
bending the arm towards an end distal from the second spring and mediate portion, to deflect from the first leaf.
